(19) United States
(12) Patent Application Publication
(10) Pub. No.: US 2006/0088370 A1
(43) Pub. Date: Apr. 27, 2006

(54) Locking lever for a cranial positioning apparatus

(76) Inventor: Joseph T. McFadden, Oxford, MS (US)

Correspondence Address: MANELLI DENISON & SELTER, 2000 M STREET NW SUITE 700, WASHINGTON, DC, 20036-3307, US

(21) Appl. No.: 10/941,944

(22) Filed: Sep. 16, 2004

(51) Int. Cl. F16B 7/10

(52) U.S. Cl. 403/109.3

(57) ABSTRACT

A locking device for positioning and locking an object in a selected position including a first arm, a second arm, a third arm and a mounting arm; the arms are structured to movably connect a support for an object to the platform; the arms are slidably and rotatably engageable with one another to allow positioning of the object in any desired position in three-dimensional space; each arm is associated with a locking lever, each locking lever is itself provided with a locking device to hold the associated arm in a closed position when actuated and which can be released by pressing on a pin; the pin is provided with spring biased detent members so that movement of the pin will move the detent members out of a restraining position to allow releasing of the lever arm.

### FIELD OF THE INVENTION

The present invention relates to an improvement in a positioning device that will permit a user to position an object with one hand and to lock the positioning device in the desired orientation with his or her other hand. The positioning device disclosed herein has particular utility in surgical procedures where the positioning of a patient's head with respect to an operating table is required and includes a safety feature in the form of a locking mechanism to prevent accidental movement of a locking device and thereby the positioning device by a worker or attendant where the positioning device has been provided with the locking mechanism.

### BACKGROUND OF THE INVENTION

A number of devices have become available to assist surgeons in carrying out surgical procedures. Of particular interest to neurosurgeons are head restraining devices that maintain a patient's head in a selected position during an operation. Such devices are in use and are disclosed in my prior U.S. Pat. No. 4,964,748 granted Oct. 23, 1990 and U.S. Pat. No. 5,560,728 granted Oct. 1, 1996. In the devices disclosed in these patents, a plurality of relatively movable arms are provided each of which is equipped with a locking lever which has one end pivotally mounted on a rod carried in a bore provided in each arm. Each movable arm is provided with such a locking lever to lock each arm at one end to a shaft which extends through a bore at one or both ends of each movable arm and about which the respective arm is movable relative to the shaft. The clamping of the lever arm is actuated to close the bore of the arm against the surface of the shaft to frictionally engage the shaft and effectively prevent relative rotation between the shaft and the movable arm. Each arm of the device is similarly equipped. It is essential to the success of the operation that the locking levers that hold the arms of the device in relative fixed positions not be accidentally released as is possible where one of the attending individuals inadvertently takes hold of a locking lever thinking it is some other device connected with the operating table or other equipement. Also, it is important that quick adjustments be possible as necessary to move the relative position of the patient's head to carry out additional steps of the surgical procedure. Also, in surgeries, unforeseen emergencies may develop which require immediate movement of the patient's head such as to facilitate the stopping or prevention of bleeding. In such circumstances, speed of release and re-actuation and locking of the clamping arm or arms is important and could not be readily achieved with the locking lever of my prior patents or of any of the prior art devices presently available.

### SUMMARY OF THE INVENTION

The present invention avoids the foregoing difficulty by providing a greatly simplified locking device for the locking lever of the arms of the head positioning apparatus. In one form, the locking device is a pushbutton operated detent pin which will allow the surgeon or an assistant to quickly either release or lock the arm without requiring visual observation of the apparatus and yet will prevent accidental release of the locking lever. Access to the locking device is achieved by virtue of the protrusion of the detent pin through the exposed surface of the locking lever. Locking of the locking lever in its closed position is also greatly facilitated by the use of a ball detent on a locking plate located adjacent to each movable arm. When the locking lever is moved to its closed position, one end of the pin will be shifted in a bore as the pin is pushed into the bore provided in the locking plate. The pin is a hollow sleeve and carries interiorly a rod which is provided with a peripheral recess. The bore in the locking plate includes a recess for receiving a portion of a ball that is carried by the hollow pin. Movement of the rod against a spring will control locking and release as described below. It will be understood that the bore in the locking plate may be provided with a number of detent type members but a ball detent is preferred. In this latter arrangement, captured balls are carried in openings near the end of a tube that itself carries the detent pin. The edges of the recess are shaped to force the balls between retracted, that is unlocked, positions, and projecting positions which effectively lock the lever arm in its closed position.

### BRIEF DESCRIPTION OF THE DRAWINGS

FIG. 1 is a perspective view showing the positioning device with which the locking mechanism of the present invention may be installed;

FIG. 2 is an elevational view partly in section of one of the main arms of the present invention on which the locking device is installed; and

FIG. 3 is an enlarged detailed view of a portion of the locking device.

### DETAILED DESCRIPTION OF THE INVENTION

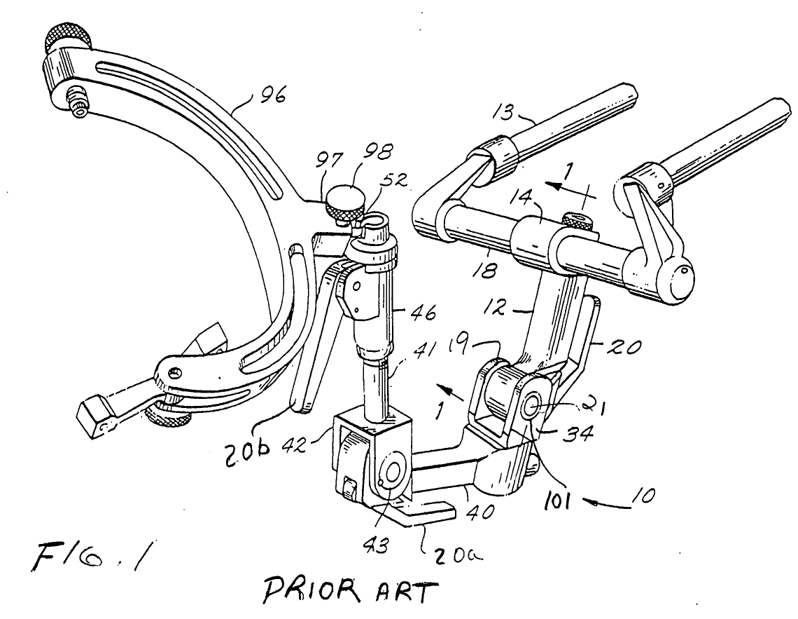

Referring now to the drawings, wherein like numerals designate corresponding parts throughout the views, there are shown, in FIG. 1, a view of the positioning device 10 of my above-mentioned prior U.S. Pat. No. 4,964,748, the disclosure of which as well as of U.S. Pat. No. 5,560,728, are incorporated herein by reference.

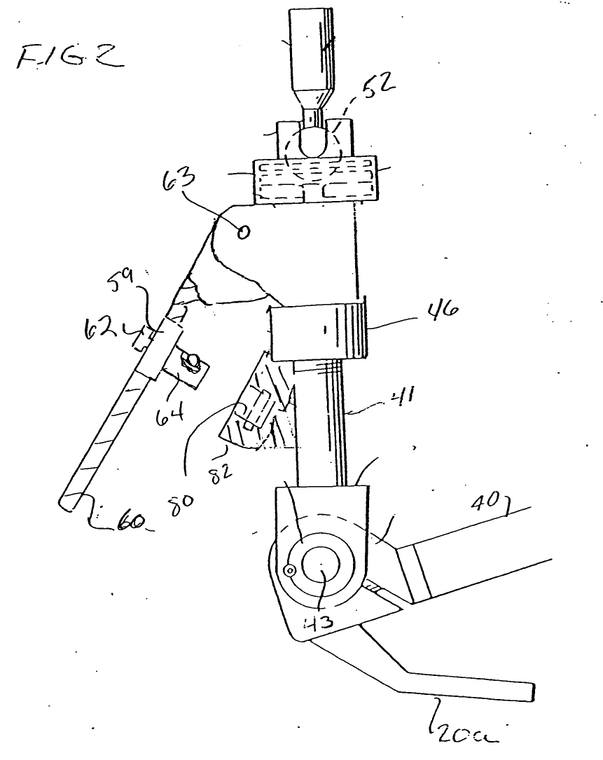

A table bracket 13 is employed to mount the apparatus 10 on a base such as the support for an operating table. The bracket 13 includes a shaft 18 to which is rotatably mounted one end of a positioning arm 14, which includes a bore through which the shaft 18 extends as shown in FIG. 1. From the end 14, the body of the arm 12 extends to a similarly shaped end 19, which has a bore (not shown) through which a pin 21 extends to support a yoke 34 for relative rotation about the pin 21. A locking lever 20, as described in more detail below, is used to clamp the end 19, and also 14 about their respective shafts 18 and 21. The clamping arm 40 is similarly shaped and mounted with parallel axes of rotation through bore 43 in yoke 42, and about shaft 21 in yoke 34 at its opposite end. A locking lever 20a is also provided and serves the same function as locking lever 20. From the yoke 42, a locking device 46 extends which one end 41 has securely attached to the yoke 42 as shown. Adjacent its free end, the locking device 46 supports a socket 52 which, in turn, movably supports a head bracket 96 of conventional construction. A locking lever 20b is associated with the locking device 46 as will be explained in more detail in connection with FIG. 2.

As noted above, actuation, that is, locking and unlocking, of the locking levers 20, 20a and 20b, in my prior art devices, has been inconvenient at best and risky at worst, especially in emergency situations during a surgical procedure. To alleviate this, the present invention provides a modified locking lever 60 which, as shown in FIG. 2, is mounted on an end of the locking device 46. It will be understood, however, that the locking lever 60 may take the place of one or both of the locking levers 20, 20a and 20b for clamping arms 12, 40 and 41.

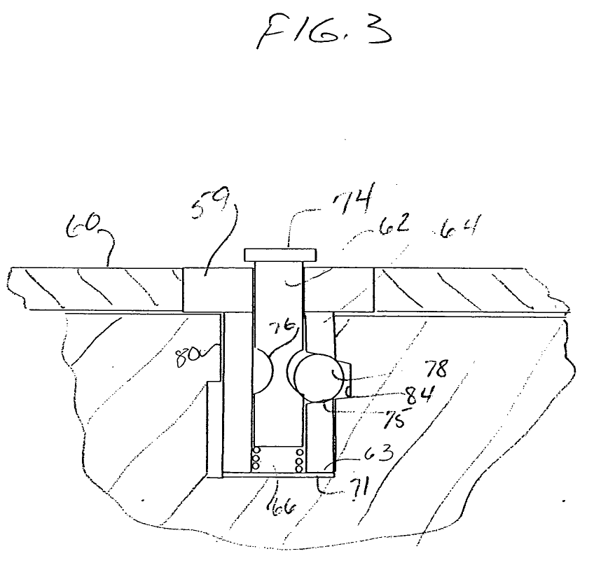

More specifically, as shown in FIGS. 2 and 3, the locking lever 60 carries a movable pin 62 slidably positioned in a tube 64, which is securely fastened to the locking lever 60 such as by a head 59 threaded or adhesively attached in an opening provided through the lever arm 60. Alternately, the head may simply be welded to the underside of the locking lever 60. The pin 62 engages a coil spring 66 housed in the tube 64 and retained by a plate 71 which is engaged by the coil spring 66 one end of which engages the plate 71 and the other end of which engages the base of the pin 62 carried by the lever 60 as shown opposite the head end 74 of the pin 62. Intermediate its opposite ends, the pin 62 has an annular recess or groove formed about its periphery and the tube 64 has a recess 75 carrying a detent ball 78 with the upper and lower edges of the recess 75 sloping away from the pin 62 so as to retain the ball 78 for limited movement transverse to the axis of the tube 64. With pin 62 in a rest position, that is, with no force transmitted to the coil spring 66, the ball 78 will be urged outwardly by the lower edge of the groove 76. However, when the tube 64 with the pin 62 is inserted into the bore 80, the ball 78 will engage the outer edge of the bore 80 at the top of the bore 80. This will push the ball into the recess 76 to allow passage of the pin 62 and tube 64 into the bore 80 until the ball 78 is adjacent the recess 84 whereupon the spring will urge the pin 62 back out of the tube 64 and the edge of the groove 76 will keep the ball 78 positioned in the recess 84 thereby locking the lever 60 in position. The recess 84 may having sloping upper and lower walls, as viewed in FIG. 3 to facilitate reception of the ball 78 under the action of the spring 66 which urges the pin 62 away from the plate 71 so that the lower edge of the groove 76 engages the ball 78 to urge the ball outwardly away from the axis of the pin 62. The interengagement of the ball 78 and the groove 84 effects locking of the lever 60 in the closed position. To unlock the lever 60, the pin 62 must be intentionally depressed by a user, against the force of spring 66, so that the recess 76 will shift downwardly along tube 64 to a position adjacent the recess 75 and ball 78. Movement of the lever 60 without depressing of the pin 62 will not effect unlocking. When so depressed, the ball will be able to be moved radially inwardly such as to an extent to leave no portion protruding from the outer edge of the recess 75. This will allow easy removal of the tube 65 carrying pin 62 from the bore 80 in locking plate 82. Intermediate its ends, the bore 80 is formed with the annular recess 84 for cooperation with the ball 78 as shown in FIG. 3. The locking device 64 is actuated when the user pivots the lever 60 so that the tube 64 will enter bore 80 provided in the locking plate 82 mounted on the arm 41. The bore 80, as shown, is provided with the annular recess 84 for engaging the outer portion of the ball 78 upon full insertion of the tube 64. Upon release of the head of the pin 62 by the user, the pin will move upwardly under the force of spring 66 so that the edge of the groove 76 of the pin 62 will again engage the ball 78 to maintain the ball in a projecting position into the recess 84 of the bore 80 ready for the next insertion.

It will be appreciated that other mechanisms may be employed to retain the pin 62 in the bore 80, but it is important that positive locking be provided to guard against accidental release of the locking lever 60. Also, as noted above, the other clamping arms 20 and 20a will preferably having locking levers provided with the locking device as described above in connection with locking lever 60. As described in my aforementioned U.S. Pat. No. 4,964,748, the locking lever 60 will function to restrain movement of a mounting pin 80 carried in the socket 52, and the operation of this portion of the lever arm 60 will be substantially the same as that described in the aforementioned patent.

Having described the invention, it will be understood that variations in the apparatus may be made without departing from the scope of the invention.

1. A device for positioning a surgical head clamp, relative to a base, comprising a plurality of arms, with one arm being connected to an adjacent arm so as to be pivotable about an end of the adjacent arm and including a locking lever on at least one of the arms to lock the associated arm against pivoting relative to the adjacent arm, the improvement comprising said locking lever having a release device comprising a pin carried by said one of said arms so as to be movable though an opening formed in said one of said arms against a spring, a portion of said pin being slidably disposed in a hollow tube having an end mounted on a side of said locking lever to extend substantially transversely therefrom and an opposite end, between said ends, said tube having movable detent means carried thereby and engageable by said pin, said pin having one segment for urging said detent means to a locking position and another segment for allowing release of said detent means from said locking position, a receptacle for said pin associated with said one arm, said receptacle including a recess for cooperation with said detent means when engaged thereby upon insertion of said pin into said receptacle, said pin having a head located on the side of said locking lever opposite to the side from which said tube extends.

2. The invention as claimed in claim 1 wherein said tube includes a transverse bore including opposite openings on the surface of said tube and said detent means are balls disposed in said transverse bore and projectable at least partially from said openings.

3. The invention as claimed in claim 2 wherein said spring constantly urges said pin in a direction away from said detent means.

4. The invention as claimed in claim 3 wherein a housing surrounds a portion of said pin adjacent said lock lever, said spring being located in said housing.
